(19) United States
(12) Patent Application Publication
(10) Pub. No.: US 2023/0217559 A1
(43) Pub. Date: Jul. 6, 2023

(54) MICROWAVE PROCESSING DEVICE, AND MICROWAVE PROCESSING METHOD

(71) Applicant: MICROWAVE CHEMICAL CO., LTD., Osaka (JP)

(72) Inventors: Yasunori TSUKAHARA, Osaka (JP); Hisao WATANABE, Osaka (JP); Ryuhei KINJO, Osaka (JP); Kazushi UEMURA, Osaka (JP); Masahiro KANNO, Osaka (JP)

(73) Assignee: MICROWAVE CHEMICAL CO., LTD., Osaka (JP)

(21) Appl. No.: 17/798,446

(22) PCT Filed: Feb. 10, 2021
(86) PCT No.: PCT/JP2021/004921

§ 371 Date: Feb. 13, 2023

(30) Foreign Application Priority Data
Feb. 10, 2020 (JP) JP 2020-020275

(51) Int. Cl. H05B 6/72; H05B 6/70

(52) U.S. Cl. CPC H05B 6/72; H05B 6/707

(57) ABSTRACT

Provided is a microwave processing apparatus that can irradiate an object with microwaves more uniformly. A microwave processing apparatus 1 includes a cavity that has a cylinder-like shape, and includes an internal space for accommodating an object, the cavity being provided with a microwave passage area in a partial region in an axial direction; a microwave generator; a rotary member that is provided on an outer circumferential side of the cavity so as to be rotatable, and includes, on an outer circumferential side of the microwave passage area, a cylinder-like member having a plurality of areas through which microwaves can pass; and a cover member that is provided while covering the entire cylinder-like member in a circumferential direction, and forms, on an outer circumferential side of the cylinder-like member, a wave guidepath for the microwaves introduced from the microwave generator.

### TECHNICAL FIELD

The present invention relates to a microwave processing apparatus and a microwave processing method that irradiates an object located in a cavity having a cylindrical shape with microwaves.

### BACKGROUND ART

Conventionally, by irradiating and heating an object (object to be heated) in a predetermined cavity with microwaves, the object is dried or subjected to a reaction, for example (see Patent Document 1). Note that microwave heating can realize selective heating, and thus is characterized by being able to fast heat an object from within and having a high heating efficiency.

### CITATION LIST

### Patent Document

[Patent Document 1] JP 2019-125534A

### SUMMARY OF INVENTION

### Technical Problem

However, there may be a possibility that a region to be heated is partially and locally heated depending on the microwave irradiation direction or the like. Therefore, there is a demand for heating a region to be heated more uniformly.

The present invention was made in view of the above-described circumstances, and it is an object thereof to provide a microwave processing apparatus and a microwave processing method that can realize, when irradiating an object located in a cavity having a cylindrical shape with microwaves, more uniform microwave irradiation of a region to be heated.

### Solution to Problem

To achieve the above-described object, according to an aspect of the present invention, a microwave processing apparatus includes: a cavity that has a cylinder-like shape, and includes an internal space for accommodating a microwave irradiation object, the cavity being provided with a microwave passage area in a partial region in an axial direction; a microwave generator configured to generate microwaves; a rotary member that is provided on an outer circumferential side of the cavity so as to be rotatable, and includes, on an outer circumferential side of the microwave passage area, a cylinder-like member having a cylindrical shape and has a plurality of areas through which microwaves can pass; and a cover member that is provided while covering the entire cylinder-like member in a circumferential direction, and forms, on an outer circumferential side of the cylinder-like member, a wave guidepath for the microwaves introduced from the microwave generator.

With this configuration, it is possible to emit microwaves that propagate in the wave guidepath formed around the cylinder-like member to an object located inside the cavity from the plurality of areas through which microwaves can pass and that are formed in the rotatable cylinder-like member. Therefore, the microwaves are emitted to a region of the object that is to be heated from various positions in the circumferential direction, resulting in realization of more uniform microwave irradiation of a region to be heated.

Also, the microwave processing apparatus according to the aspect of the present invention, the areas of the cylinder-like member through which microwaves can pass may be slit-shaped areas.

With this configuration, similar to microwaves leaking from slots of a leakage waveguide, microwaves can be emitted to the object located inside the cavity more uniformly

Also, the microwave processing apparatus according to the aspect of the present invention, the slit-shaped areas may extend in the circumferential direction of the cylinder-like member.

With this configuration, it is possible to realize more efficient microwave irradiation than in a case where the slit areas extend in the axial direction of the cylinder-like member.

Also, the microwave processing apparatus according to the aspect of the present invention, the microwave passage area may be constituted by a member made of a microwave transmitting material.

With this configuration, even if, for example, water vapor, gas, or the like is generated in response to heating of the object, it is possible to prevent such water vapor, gas, or the like from moving toward the microwave generator. As a result, it is possible to prevent failures of the microwave generator, and the like.

Also, the microwave processing apparatus according to the aspect of the present invention, the microwave passage area may be provided over the entire portion of the cavity in a circumferential direction.

With this configuration, it is possible to irradiate the object with microwaves in all circumferential directions, realizing more uniform irradiation of the entire object with microwaves.

Also, according to an aspect of the present invention, a microwave processing method includes the steps of; rotating, on an outer circumferential side of a microwave passage area provided in a partial region of a cavity in an axial direction, a cylinder-like member that has a cylindrical shape and has a plurality of areas through which microwaves can pass, the cavity having a cylinder-like shape and including an internal space for accommodating a microwave irradiation object; and introducing microwaves into a wave guidepath for microwaves, and irradiating the microwave irradiation object located in the cavity with the microwaves, the wave guidepath for microwaves being formed on an outer circumferential side of the cylinder-like member by a cover member provided while covering the entire cylinder-like member in a circumferential direction.

### Advantageous Effects of Invention

With the microwave processing apparatus according to the aspect of the present invention, it is possible to realize more uniform microwave irradiation to a region to be heated of an object in a cavity.

### BRIEF DESCRIPTION OF DRAWINGS

FIG. 1 is a perspective view illustrating a microwave processing apparatus according to an embodiment of the present invention.

FIG. 2 is a perspective view illustrating a cavity and a rotary member according to the embodiment.

FIG. 3 is a perspective view illustrating the cavity according to the embodiment.

FIG. 4A is a front view illustrating a cylindrical member according to the embodiment.

FIG. 4B is a vertical cross-sectional view of the cylindrical member according to the embodiment.

FIG. 5 is a cross-sectional view taken along a plane perpendicular to an axial direction of the microwave processing apparatus according to the embodiment.

FIG. 6 is a cross-sectional view taken along a plane passing through the central axis of the microwave processing apparatus according to the embodiment.

FIG. 7 is a diagram illustrating a rotation mechanism for the rotary member according to the embodiment.

### DESCRIPTION OF EMBODIMENT

Hereinafter, the microwave processing apparatus and the microwave processing method according to the present invention will be described with reference to an embodiment. Note that in the following embodiment, constituent components denoted by the same reference numerals are identical or correspond to each other, and thus redundant descriptions may be omitted. In the microwave processing apparatus according to the present embodiment, a microwave passage area is provided in a part of a cavity having a cylindrical shape in an axial direction thereof, and a wave guidepath for microwaves is formed over the entire outer circumference of the passage region in a circumferential direction. An object located in the cavity is irradiated with microwaves propagating in the wave guidepath via a cylindrical member that rotates on the outer circumferential side of the microwave passage area in the circumferential direction, and has a plurality of regions through which microwaves can pass.

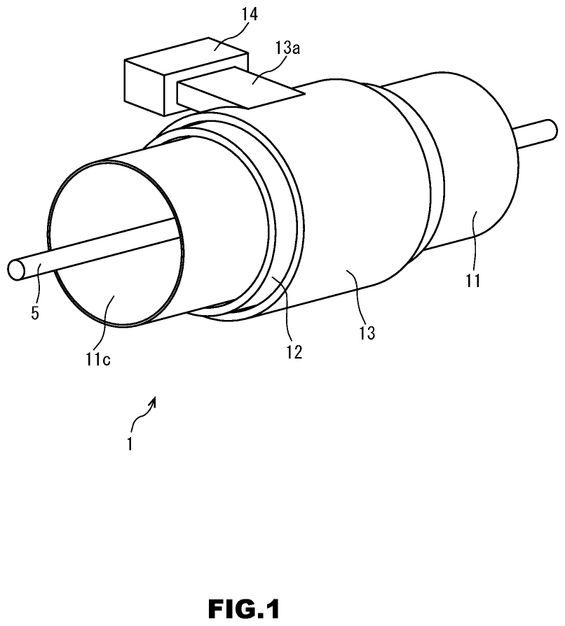

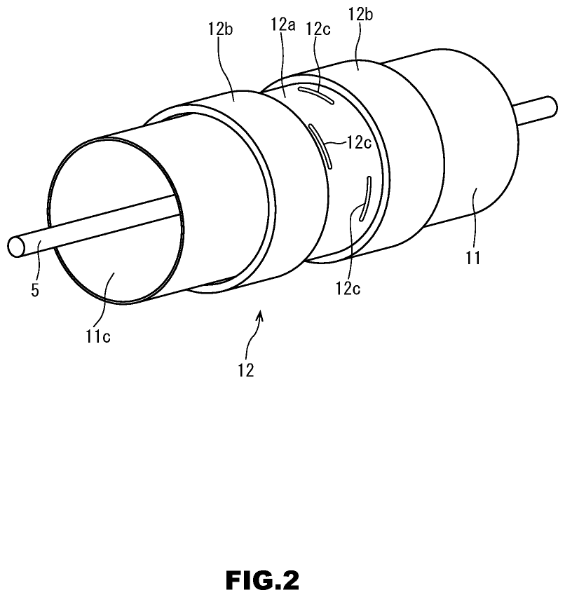

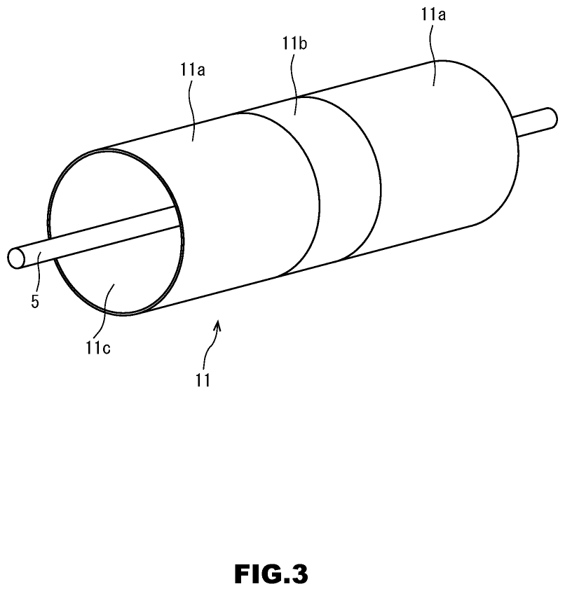

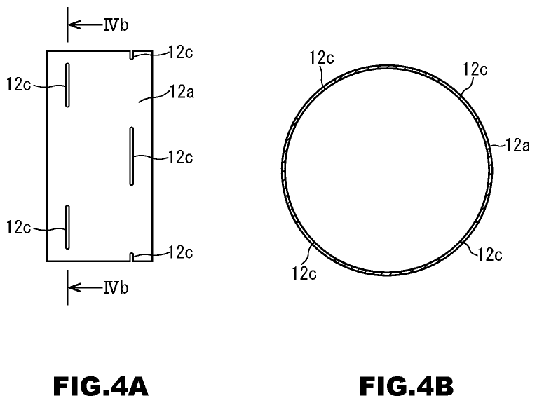

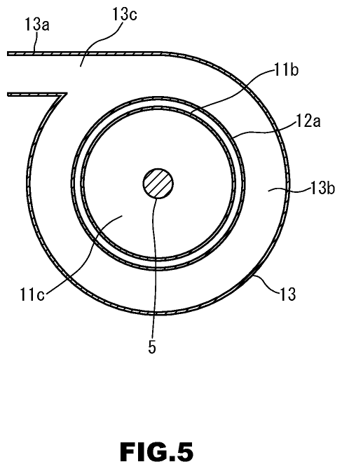

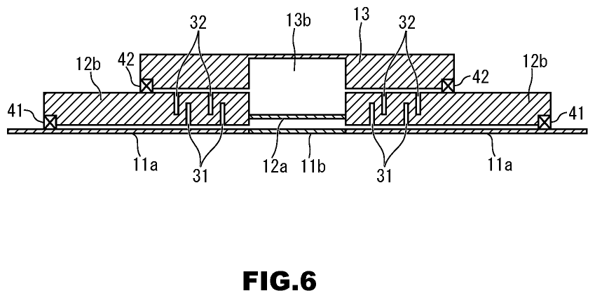

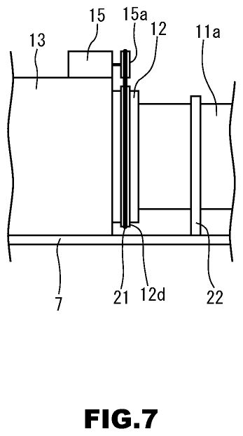

FIG. 1 is a perspective view showing a main configuration of a microwave processing apparatus 1 according to the present embodiment. FIG. 2 is a perspective view showing a rotary member 12 provided on the outer circumferential side of a cavity 11 so as to be rotatable. Note that FIG. 2 shows a state in which a cover member 13 shown in FIG. 1 was removed. FIG. 3 is a perspective view showing an outer appearance of the cavity 11. Note that FIG. 3 shows a state in which the rotary member 12 shown in FIG. 2 was removed. FIG. 4A is a front view showing a configuration of a cylindrical member 12a included in the rotary member 12, and FIG. 4B is a cross-sectional view taken along a line IVb-IVb in FIG. 4A. FIG. 5 is a vertical cross-sectional view only showing an end surface of a cross section taken along a plane that is perpendicular to the axial direction of the microwave processing apparatus 1 shown in FIG. 1 and extends through a waveguide 13a. Note that in FIG. 5, illustration of a microwave generator 14 is omitted. FIG. 6 is a vertical cross-sectional view taken along a plane parallel to the axial direction of the microwave processing apparatus 1 shown in FIG. 1. Note that FIG. 6 only shows the upper side of the microwave processing apparatus 1. FIG. 7 is a diagram illustrating a rotation mechanism for the rotary member 12.

The microwave processing apparatus 1 according to the present embodiment includes the cavity 11, the rotary member 12, the cover member 13, the microwave generator 14, and a rotary drive unit 15. Any type of object 5 may be irradiated with and heated by microwaves. The object 5 may be, for example, an elongated solid object, an elongated hollow object, or another type of elongated object. Note that, for example, one elongated object 5 or two or more elongated objects 5 may be put into the cavity 11. The object 5 may also be an object other than an elongated one, such as a granular solid, powder, or fluid, for example. The object 5 such as a granular solid, powder, or fluid may flow in a pipe or the like laid inside the cavity 11, for example. The pipe or the like may be made of a microwave transmitting material. Examples of the microwave transmitting material will be given later. In a case where the object 5 is an elongated object, a configuration for supporting the object 5 may also be provided inside or outside the cavity 11. Preferably, the object 5 is arranged near the central axis of an internal space 11c of the cavity 11.

While being irradiated with microwaves, the object 5 arranged in the internal space 11c of the cavity 11 may or may not move. That is to say, processing performed by irradiating the object 5 with microwaves may be continuous processing or batch processing. When continuous processing is performed on the object 5, the object 5 may continuously move, or may repeat moving and stopping, for example. When continuous processing is performed on the object 5, a mechanism for transporting the object 5 may be provided inside or outside the cavity 11, for example.

The irradiation of the object 5 with microwaves may be performed, for example, to dry the object 5, or may be performed to melt, sublimate, or evaporate the object 5. The irradiation of the object 5 with microwaves may also be performed to subject the object 5 to a reaction, to sterilize the object, or for other usages. The reaction of the object may be a chemical reaction, for example.

The cavity 11 is a cavity that has a cylindrical shape and includes the internal space 11c for accommodating the object 5 to be irradiated with microwaves. In the internal space 11c of the cavity 11, the object 5 is irradiated with microwaves. The mode of microwaves in the space 11c is typically a multimode. As shown in FIG. 3, the cavity 11 includes a cavity main body 11a, and a microwave passage area 11b provided in a partial region of the cavity 11 in the axial direction. The microwave passage area 11b may be provided over the entire portion of the cavity 11 in the circumferential direction, or in a partial portion of the cavity 11 in the circumferential direction. In the latter case, for example, the microwave passage area 11b may be provided only in a partial region of the cavity 11 in the circumferential direction, and the microwave passage area 11b and an area through which no microwave pass may be provided alternately in the circumferential direction. The area through which no microwave pass may be made of a microwave reflective material. Examples of the microwave reflective material will be given later. The present embodiment mainly describes a case where the microwave passage area 11b is provided over the entire portion of the cavity 11 in the circumferential direction. The cavity main body 11a and the microwave passage area 11b typically have a hollow cylindrical shape, that is, the shape of a pipe. Note that the axial direction refers to a direction of the central axis of the cylindrical shape of the cavity 11. Also, a direction of the circumference of the cylindrical shape may be referred to as a circumferential direction. Also, a direction of a straight line extending through the central axis in a plane perpendicular to the axial direction of the cylindrical shape may be referred to as a radial direction. Also, the cavity 11 may typically be arranged such that the central axis thereof is directed in a substantially horizontal direction, but may also be arranged such that the central axis thereof is directed in a direction other than the horizontal direction, such as e.g., a vertical direction.

The cavity main body 11a is preferably a component through which no microwave pass. The cavity main body 11a may be made of a microwave reflective material. The microwave reflective material may be a metal, for example. The metal is not particularly limited, and may be, for example, a stainless steel, a carbon steel, nickel, a nickel alloy, copper, a copper alloy, or the like. As shown in FIG. 7, the cavity main body 11a may also be fixed to a base 7 by a supporting part 22. Note that FIG. 7 is a diagram of the microwave processing apparatus 1 when viewed in a direction perpendicular to the axial direction. Also, in FIGS. 1 to 3, illustrations of the rotary drive unit 15, the base 7, and the supporting part 22 are omitted. The region of the outer circumference of the cavity main body 11a that is not covered with the rotary member 12 or the cover member 13 may be covered with a heat insulation material, a jacket, or the like.

When continuous processing is performed on an object 5, an entrance and an exit through which the object 5 is passed may be provided at end portions of the cavity 11 in the axial direction. Also, to prevent microwaves inside the cavity 11 from leaking to the outside, the entrance and the exit may also be provided with a mechanism for preventing leakage of microwaves such as a choke structure. Also, when irradiation with microwaves is performed in batch processing, the end portions of the cavity 11 in the axial direction may be closed. Note that, for example, the end portions may also be openable and closable, in order for an operator to bring the object 5 into and out of the cavity 11.

The microwave passage area 11b may be an open area without any substance for example, or may be constituted by a member made of a microwave transmitting material. The present embodiment will mainly describe the latter case, that is, a case where the microwave passage area 11b is constituted by a member that has a cylindrical shape and is made of a microwave transmitting material. As a result of the microwave passage area 11b being closed in this manner, it is possible to prevent water vapor, gas, and the like generated by heating the object 5 arranged in the internal space 11c of the cavity 11 from flowing toward the microwave generator 14 via the microwave passage area 11b, making it possible to prevent failures of the microwave generator 14, or the like. Accordingly, it is preferable that no gap be formed between the microwave passage area 11b, which is a member that has a cylindrical shape and is made of a microwave transmitting material, and the cavity main body 11a. The cavity main body 11a and the microwave passage area 11b, which is a member having a cylindrical shape, may also be connected to each other by screw fastening, bonding, or the like, for example.

A microwave transmitting material is a material having a small relative dielectric loss, and may be, without being specifically limited to, a fluoroethylene resin such as polytetrafluoroethylene, quartz, glass, or the like, for example. The relative dielectric loss of the microwave transmitting material is preferably less than 1, more preferably less than 0.1, and further preferably less than 0.01, under, for example, the frequency and the temperature of microwaves during operation of the microwave processing apparatus 1.

Within the cavity 11, air may be blown in the axial direction. If, for example, the object 5 is dried by microwave irradiation, the air blow may discharge humid air. Also, the object 5 may be preliminarily heated by a heating means other than microwaves before being irradiated with microwaves. A heating means other than microwaves may be, for example, an electric heater, a gas heater, or the like.

The rotary member 12 is a member that has a cylindrical shape and is provided on the outer circumferential side of the cavity 11 so as to be rotatable, and includes, as shown in FIG. 2, the cylindrical member 12a, and rotating support members 12b that support the cylindrical member 12a from both sides in the axial direction. Note that the cylindrical member 12a and the rotating support members 12b may be, for example, separate members or may be formed as one piece. The present embodiment mainly describe a case where they are separate members. When the cylindrical member 12a and the rotating support members 12b are separate members, they may be connected to each other by screw fastening, bonding, welding, or the like, for example.

The cylindrical member 12a is a member having a cylindrical shape, and is arranged on the outer circumferential side of the microwave passage area 11b. Note that the length of the cylindrical member 12a in the axial direction, and the length of the microwave passage area 11b in the axial direction are preferably the same. Also, the position of the cylindrical member 12a in the axial direction and the position of the microwave passage area 11b in the axial direction are preferably the same. As shown in FIGS. 4A and 4B, a plurality of areas 12c through which microwaves can pass are formed in a surface of the cylindrical member 12a, that is, a side surface of the cylindrical shape. The plurality of areas 12c may be open areas without any substance for example, or may be constituted by members made of a microwave transmitting material. In the latter case, for example, openings formed in the side surface of the cylindrical member 12a made of a microwave reflective material may be closed by a substance made of a microwave transmitting material. Examples of the microwave transmitting material and the microwave reflective material are as described above. Typically, the plurality of areas 12c are provided on the surface of the cylindrical member 12a in an evenly-distributed manner, but another configuration is also possible. As shown in FIG. 4A, the shape of the areas 12c may be, for example, a slit shape, a round shape, a square shape, or the like. When the areas 12c have a slit shape, the slit-shaped areas 12c may extend, for example, in the circumferential direction of the cylindrical shape as shown in FIG. 4A, or may extend in the axial direction of the cylindrical shape or in another direction. FIG. 4A shows a case where the slit-shaped areas 12c are provided at two portions in the axial direction, that is, the slit-shaped areas 12c are provided in two lines, but the slit-shaped areas 12c may also be provided in only one line, or in three or more lines. Also, FIGS. 4A and 4B show a case where four slit-shaped areas 12c are provided in each line at every 90 degrees in the circumferential direction, but a configuration is also possible in which N slit-shaped areas 12c are provided in each line at every (360/N) degrees in the circumferential direction. Here, N is an integer number of 2 or more. Also, the plurality of microwave areas 12c may be provided in such a manner as not to be lined up in lines.

Note that, in order for microwaves to efficiently pass through the areas 12c from a wave guidepath 13b formed by the cover member 13 and enter into the cylindrical member 12a, the slit-shaped areas 12c preferably extend in the circumferential direction of the cylindrical shape. It is also preferable that the distances, in the circumferential direction and the axial direction, between the slit-shaped areas 12c extending in the circumferential direction be set so as to allow microwaves to easily enter the inside of the cylindrical member 12a. The distances may be, for example, the same distances as those in well-known leakage waveguides, which are square-shaped waveguides provided with, in a surface thereof, a plurality of slit-shaped slots extending in the longitudinal direction.

The rotating support members 12b support the cylindrical member 12a, and as a result of the rotating support members 12b rotating on the outer circumferential side of the cavity 11, the cylindrical member 12a is rotated together. Accordingly, the rotating support members 12b support the cylindrical member 12a so that the cylindrical member 12a is rotatable on the outer circumferential side of the microwave passage area 11b.

The cylindrical member 12a excluding the plurality of areas 12c, and the rotating support member 12b are preferably made of a material that does not allow passage of microwaves. The cylindrical member 12a excluding the plurality of areas 12c, and the rotating support members 12b may be made of a microwave reflective material. The microwave reflective material may be a metal, for example. Examples of the metal are as described above.

The cover member 13 is provided while covering the entire cylindrical member 12a in the circumferential direction. The cover member 13 does not rotate with respect to the cavity 11. Therefore, the rotary member 12 rotates in the circumferential direction between the cavity 11 and the cover member 13. As shown in FIG. 7, the cover member 13 may be fixed to the base 7. With the cover member 13, the wave guidepath 13b for microwaves introduced from the microwave generator 14 is formed on the outer circumferential side of the cylindrical member 12a. The wave guidepath 13b has a hollow cylindrical shape. It is also conceivable that the wave guidepath 13b has the same shape as a hollow cylindrical shape that is formed by bending a square waveguide into a round shape. The wave guidepath 13b is formed also using components other than the cover member 13. In the present embodiment, as shown in FIGS. 5 and 6, the wave guidepath 13b is constituted by the cylindrical member 12a, the rotating support members 12b, and the cover member 13. More specifically, the outer circumferential surface of the wave guidepath 13b is formed by the cover member 13, the inner circumferential surface of the wave guidepath 13b is formed by the outer circumferential surface of the cylindrical member 12a, and side surfaces (that is, surfaces that connect the outer circumferential surface and the inner circumferential surface) of the wave guidepath 13b are formed by the cover member 13 and the rotating support members 12b. Note that if the thickness of the rotating support member 12b in a radial direction is about the same as that of the cylindrical member 12a, the wave guidepath 13b may be formed by the cylindrical member 12a and the cover member 13.

The wave guidepath 13b has an opening 13c for introducing microwaves generated by the microwave generator 14. The cover member 13 may have a waveguide 13a connected to the opening 13c. Also, by the waveguide 13a, the microwaves from the microwave generator 14 are guided to the wave guidepath 13b. As shown in FIG. 5, preferably, the waveguide 13a is provided while extending in a tangential direction of the wave guidepath 13b having a hollow cylindrical shape. Note that if the cover member 13 does not include the waveguide 13a, the microwave generator 14 may also be directly connected to the opening 13c.

The cross section taken along a plane perpendicular to the circumferential direction of the wave guidepath 13b preferably has the same size as the cross section of a square waveguide suitable for the frequency of microwaves that propagate in the wave guidepath 13b. For example, if microwaves of 2.45 GHz propagate in the wave guidepath 13b, the length of the wave guidepath 13b in the axial direction may be 109.2 (mm), and the length of the wave guidepath 13b in the radial direction may be 54.6 (mm).

Preferably, the cover member 13 is a member through which no microwave pass. The cover member 13 may be made of a microwave reflective material. The microwave reflective material may be a metal, for example. Examples of the metal are as described above.

Note that the present embodiment shows a case where the outer shape of the cover member 13 is a cylindrical shape, but the cover member 13 does not need to have such a shape. The outer shape of the cover member 13 may also be a cuboid shape or the like. Even in this case, the inner circumferential surface of the cover member has a cylindrical shape since the inner circumferential surface of the cover member forms the wave guidepath 13b or allows the rotary member 12 to rotate.

As shown in FIG. 6, the rotary member 12 may be provided so as to be rotatable on the outer circumferential side of the cavity 11 by using ball bearings 41. Note that gaps formed between the outer circumferential surface of the cavity 11 and the inner circumferential surfaces of the rotating support members 12b preferably have a constant length in the radial direction. Also, the rotary member 12 may be provided so as to be rotatable on the inner circumferential side of the cover member 13 by using ball bearings 42. Note that gaps formed between the outer circumferential surfaces of the rotating support members 12b and the inner circumferential surface of the cover member 13 preferably have a constant length in the radial direction. The ball bearings 41, 42 may be provided at positions different from the positions shown in FIG. 6, and a larger number of ball bearings may also be provided. Note that the ball bearings 41, 42 may also be provided at positions at which entry of microwaves is blocked by a later-described leakage prevention mechanism, so that the ball bearings 41, 42 are prevented from being irradiated with microwaves. In FIGS. 1 to 3, for ease of description, illustration of the ball bearings 41, 42 is omitted.

Also, choke structures 31, 32 shown in FIG. 6 are provided as the leakage prevention mechanisms for preventing microwaves propagating in the wave guidepath 13b from leaking outward from the gaps between the cavity 11 and the rotating support members 12b, and the gaps between the cover member 13 and the rotating support members 12b. Note that choke structures are already well-known, and thus a detailed description thereof is omitted. In the present embodiment, a case is described where the choke structures 31, 32 are provided on the rotating support members 12b, but the choke structures may also be provided on, for example, the cavity 11 side or the cover member 13 side.

Also, the cavity 11, the cylindrical member 12a, the rotating support members 12b, the inner circumferential surface of the wave guidepath 13b of the cover member 13, and the inner circumferential surface of the portion of the cover member 13 that faces the outer circumferential surface of the rotary member 12 are preferably concentric. Also, the rotation axis of the rotary member 12 preferably matches the central axes of the cavity 11 and the like.

The microwave generator 14 generates microwaves. The microwave generator 14 may use, for example, magnetron, klystron, gyrotron, or the like to generate microwaves, or may use a semiconductor element to generate microwaves. Microwaves may have a frequency of, for example, 915 MHz, 2.45 GHz, 5.8 GHz, or 24 GHz, or may have another frequency in a range from 300 MHz to 300 GHz. Also, the intensity of microwaves may be controlled as appropriate by a not-shown control unit. The control may be feedback control that uses sensing results such as, for example, the temperature in the cavity 11, the temperature of the object 5, and the amount of moisture of the object 5.

The rotary drive unit 15 rotates the rotary member 12 with respect to the cavity 11. The rotary drive unit 15 may be, for example, a motor or the like. The rotary drive unit 15 may be fixed, for example, to the cover member 13 as shown in FIG. 7, or may be fixed to the base 7. As shown in FIG. 7, a chain 21 is wound around a chain wheel 15a that is rotated by the rotary drive unit 15 and a chain wheel 12d that is provided on the rotary member 12, and as a result of the chain wheel 15a being rotated by the rotary drive unit 15, the rotary member 12 is rotated. The rotation may be directed in the same direction as that of microwaves propagating in the wave guidepath 13b, or may be directed in an inverted direction. In the former case, the cylindrical member 12a is rotated clockwise in FIG. 5, and in the latter case, the cylindrical member 12a is rotated counterclockwise in FIG. 5. Also, the rotary drive unit 15 may swing the rotary member 12. Note that the swing is preferably performed in a range of angles at which the object 5 is irradiated uniformly with microwaves. Note that it will be appreciated that a mechanism other than the mechanism shown in FIG. 7 may be used as the rotation mechanism for rotating the rotary member 12.

The rotary drive unit 15 may or may not rotate the rotary member 12 at a constant rotation speed. Also, if the rotary member 12 is rotated in one direction and continuous processing is performed, the rotary drive unit 15 may rotate the rotary member 12 at a rotation speed at which, for example, the rotary member 12 is rotated by 360 degrees or more while the object 5 moves for the length of the wave guidepath 13b in the axial direction. Also, if the rotary member 12 is rotated in one direction, continuous processing is performed, and the areas 12c of the cylindrical member 12a are M-fold symmetric (that is, the positions of the areas 12c match each other when the cylindrical member 12a is rotated by (360/M) degrees), the rotary drive unit 15 may rotate the rotary member 12 at a rotation speed at which, for example, the rotary member 12 is rotated by (360/M) degrees or more while the object 5 moves for the length of the wave guidepath 13b in the axial direction. Here, M is an integer number of 2 or more.

The following will briefly describe a method in which the microwave processing apparatus 1 according to the present embodiment irradiates the object 5 with microwaves. In a case of batch processing, the object 5 is arranged in the cavity 11 so as to be in a resting state, and in a case of continuous processing, the object 5 is moved in the axial direction in the cavity 11. Then, microwaves are generated by the microwave generator 14, and the rotary member 12 is rotated by the rotary drive unit 15. As a result, the microwaves guided from the microwave generator 14 to the wave guidepath 13b are emitted to the object 5 via the areas 12c of the rotating cylindrical member 12a and the microwave passage area 11b. Here, since the cylindrical member 12a rotates on the outer circumferential side of the cavity 11, the microwaves are emitted to the object 5 from various positions in the circumferential direction. As a result, it is possible to realize uniform irradiation of the object 5 with the microwaves.

As described above, according to the microwave processing apparatus 1 of the present embodiment, by irradiating the object 5 inside the cavity 11 with microwaves that propagates in the wave guidepath 13b provided on the outer circumferential side of the cavity 11, via the plurality of areas 12c of the cylindrical member 12a rotating on the inner circumferential side of the wave guidepath 13b, it is possible to realize more uniform heating of the object 5. As a result, it is possible to realize more uniform drying of the object 5, and more uniform reaction of the object 5, for example. Note that, as described above, the microwave passage area 11b may be provided in a partial portion of the cavity 11 in the circumferential direction. Specifically, the microwave passage area 11b may only be provided in a lower portion of the cavity 11. In this case, the object 5 is irradiated with microwaves only from below, but this irradiation is made via the plurality of areas 12c, through which microwaves can pass, of the rotating cylindrical member 12a, and thus it is possible to realize more uniform heating of a region of the object 5 (in this case, the lower region, for example) that is to be subjected to microwave irradiation.

Note that the present embodiment has described a case where irradiation with microwaves is performed at one position of the cavity 11 in the axial direction, but irradiation with microwaves may also be performed at two or more positions of the cavity 11 in the axial direction. In this case, microwave passage areas 11b and the cylindrical member 12a may be provided at two or more positions of the cavity 11 in the axial direction, and wave guidepaths 13b for microwaves may be formed at the two or more positions. Note that, for example, one rotary member 12, one cover member 13, and one rotary drive unit 15 may be provided for each wave guidepath 13b for microwaves, or may be provided for a plurality of wave guidepaths 13b for microwaves. In the latter case, the rotary member 12 includes a plurality of cylindrical members 12a, and the cover member 13 forms a plurality of wave guidepaths 13b. Also, when irradiation with microwaves is performed at two or more positions of the cavity 11 in the axial direction, the microwave processing apparatus 1 may include one microwave generator 14, or may include a plurality of microwave generators 14. In the former case, microwaves generated by one microwave generator 14 may be branched and emitted. Also, when a plurality of microwave generators 14 are used, microwaves generated by the microwave generators 14 may have the same frequency, or may have different frequencies.

Also, the present embodiment has described a case where microwaves generated by the microwave generator 14 are introduced into the wave guidepath 13b by the waveguide 13a, but microwaves generated by the microwave generator 14 may be introduced into the wave guidepath 13b by another transmission means such as a coaxial cable. When microwaves are transmitted by a coaxial cable, an antenna for radiating microwaves that is connected to the coaxial cable may be provided in the wave guidepath 13b.

Also, the present embodiment has described a case where the length of the rotary member 12 in the axial direction is larger than that of the cover member 13, but another configuration is also possible. The length of the cover member 13 in the axial direction may be larger than that of the rotary member 12 as long as a mechanism for rotating the rotary member 12 can be installed.

Also, the present embodiment has been described on the assumption that the cavity 11 is cylindrical, that is to say, the cross section of the cavity 11 that is perpendicular to the axial direction thereof has the shape of a precise circle, but the cavity 11 may have a cross section having a shape slightly deviated from a precise circle, for example, an ellipsoidal shape or a regular polygonal shape, and the shape of the cavity 11 may be sometimes referred to as a “cylinder-like shape”. In the latter case, also the rotary member 12 may have a cylinder-like shape whose cross section perpendicular to the axial direction is slightly deviated from a precise circle, and the rotary member 12 may be rotatable on the outer circumferential side of the cavity 11.

It will be appreciated that the present invention is not limited to the above-described embodiments, and various modifications are possible which are intended to be encompassed within the scope of the present invention.

### INDUSTRIAL APPLICABILITY

As described above, the microwave processing apparatus and the microwave processing method according to the aspects of the present invention can achieve effects of enabling more uniform irradiation of an object in a cavity with microwaves. The present invention is useful for a microwave processing apparatus and a microwave processing method that irradiates an object with microwaves.

1. A microwave processing apparatus comprising:
a cavity comprising a cylinder-like shape, and includes an internal space accommodating a microwave irradiation object, the cavity being provided with a microwave passage area in a partial region in an axial direction;
a microwave generator configured to generate microwaves;
a rotary member that is provided on an outer circumferential side of the cavity so as to be rotatable, and includes, on an outer circumferential side of the microwave passage area, a cylinder-like member having a plurality of areas through which microwaves can pass; and
a cover member that is provided while covering the entire cylinder-like member in a circumferential direction, and forms, on an outer circumferential side of the cylinder-like member, a wave guidepath for the microwaves introduced from the microwave generator.

2. The microwave processing apparatus according to claim 1,
wherein the areas of the cylinder-like member through which microwaves can pass are slit-shaped areas.

3. The microwave processing apparatus according to claim 1,
wherein the microwave passage area is constituted by a member made of a microwave transmitting material.

4. The microwave processing apparatus according to claim 1,
wherein the microwave passage area is provided over the entire portion of the cavity in a circumferential direction.

5. A microwave processing method comprising the steps of:
rotating, on an outer circumferential side of a microwave passage area provided in a partial region of a cavity in an axial direction, a cylinder-like member having a plurality of areas through which microwaves can pass, the cavity having a cylinder-like shape and including an internal space for accommodating a microwave irradiation object; and
introducing microwaves into a wave guidepath for microwaves, and
irradiating the microwave irradiation object located in the cavity with the microwaves, the wave guidepath for microwaves being formed on an outer circumferential side of the cylinder-like member by a cover member provided while covering the entire cylinder-like member in a circumferential direction.
